(19) United States
(12) Patent Application Publication
(10) Pub. No.: US 2008/0319618 A1
(43) Pub. Date: Dec. 25, 2008

(54) Method for Optimizing Operation of a Work Vehicle

(75) Inventors: Joakim Sjogren, Koping (SE); Susanna Thorn, Eskilstuna (SE)

Correspondence Address: WRB-IP LLP, 1217 KING STREET, ALEXANDRIA, VA, 22314, US

(73) Assignee: Volvo Construction Equipment AB, Eskilstuna (SE)

(21) Appl. No.: 12/279,203

(22) PCT Filed: Feb. 20, 2006
(86) PCT No.: PCT/SE06/00224

§ 371 Date: Aug. 13, 2008

(51) Int. Cl. F02D 45/00

(52) U.S. Cl. 701/50; 123/379

(57) ABSTRACT

A method is provided for optimizing operation of a work vehicle with an engine for propelling the vehicle. The method includes detecting at least one operating parameter, determining an optimized engine speed parameter value with regard to fuel consumption, reduced emissions and/or increased productivity on the basis of the detected operating parameter and stored information regarding fuel consumption, emissions and/or productivity, and controlling the engine in accordance with the determined engine speed parameter value.

### BACKGROUND AND SUMMARY

The present invention relates to a method for optimizing operation of a work vehicle.

The term “work vehicle” comprises different types of material handling vehicles like construction machines, such as a wheel loader, an articulated hauler, a backhoe loader, a motor grader and an excavator. Further terms frequently used for work vehicles are “earth-moving machinery” and “off-road work machines”. The invention will be described below in a case in which it is applied in a wheel loader. This is to be regarded only as an example of a preferred application.

The work vehicles are for example utilized for construction and excavation work, in mines etc.

Work vehicles are designed to perform different work cycles. The work cycles for a wheel loader may comprise a transportation cycle (>500 m), a load carrying cycle (75-500 m), a close handling cycle (15-75 m) and a short-cycle loading (0-15 m).

During the transportation cycle, the wheel loader is forwarded to a loading site (for example a heap of gravel) while filling the bucket. The wheel loader is thereafter reversed and turned and driven forwards again to an unloading site. The bucket is unloaded, for example on a container of an articulated hauler or truck. The wheel loader is thereafter reversed and turned again, and driven back to the loading site.

Thus, a wheel loader may be used to transport heavy loads from one location to another, often encountering a series of turns and varying grade slopes on the route between two or more locations.

Operating the work vehicle with a high number of revolutions of the vehicle engine normally leads to a high fuel consumption. In order to reduce fuel consumption, a work vehicle may be equipped with an operator-controlled element, for example a button, for selection of an economy mode, which limits the maximum number of revolutions of the vehicle engine to e.g 1600 rpm. A maximum depression of an electronic gas pedal will in such a case not lead to a maximum available number of revolutions of the engine, but instead only to 1600 rpm. However, it has turned out that the vehicle operator hesitates to use the economy mode since the vehicle feels powerless when for example traveling uphills with a high load.

Further, in the future oil seems to be a limited resource and therefore fuel consumption is a really interesting parameter due to cost. Today the trading with emission rights has started and that is also an aspect to consider. Environmental targets are set all over the world to reduce the emissions of green house gases. Green house gases conduce to global warming that can lead to climate changes in the future. Thus, there is an increasing desire to make the vehicles more environmental-friendly in operation.

There is of course also a desire to increase productivity of the work vehicle during operation.

Work vehicles are today often used by unexperienced drivers and the above mentioned problems are then further elevated.

It is desirable to achieve a method for enhancing operation of a work vehicle with regard to fuel economy, emissions and/or productivity.

A method according to an aspect of the present invention is provided comprising the steps of detecting at least one operating parameter, determining an optimized engine speed parameter value with regard to fuel consumption, reduced emissions and/or increased productivity on the basis of the detected operating parameter and stored information regarding fuel consumption, emissions and/or productivity, and controlling the engine in accordance with the determined engine speed parameter value.

It has turned out that, at least for certain operative conditions, there are more efficient engine operation regions for the vehicle with regard to fuel economy, emissions and/or productivity than the region defined by only a limited maximum available engine speed. Thus, the invention aims for optimizing the engine speed parameter with regard to fuel economy, emissions and/or productivity. In other words, the invention actively compares/balances effects of fuel consumption, emissions and/or productivity e.g. for traveling uphill and selects a maximum available engine number of revolutions or engine torque for the performance in question.

According to one embodiment, the optimized engine speed parameter value is an engine speed value, and the method comprises the step of controlling the actual engine speed to the determined engine speed value (number of revolutions of the engine).

For example, it has turned out that a less total fuel consumption may be achieved for traveling a distance uphill with a higher number of revolutions of the engine. This is due to that the total time for performing the transport is decreased. Further, the emissions are reduced when traveling the distance uphills with a higher number of revolutions of the engine in a shorter time. An economy mode of the vehicle normally limits a maximum available number of revolutions of a vehicle engine. According to the described example, it is advantageous to raise the limit of the maximum available number of revolutions of the vehicle engine when an economy mode is selected by the driver for traveling the distance uphills.

Further, the vehicle operator is often hesitant to use the economy mode since the vehicle feels powerless when for example traveling uphill with a load. Thanks to the invention, in case the limit of the maximum available number of revolutions of the vehicle engine is raised, the vehicle will also feel stronger for the operator.

According to a further embodiment, the method comprises the step of detecting actuation of an operator-controlled element which is adapted for requesting an engine speed and initiating determination of the engine speed parameter value if full engine speed is requested by the operator. The operator-controlled element is for example a gas pedal. A full depression of the gas pedal initiates the process of determining the engine speed parameter value. Thus, according to one example, when the vehicle is in the fuel economy mode and the operator depresses the gas pedal to its full extent, the engine is controlled so that the number of revolutions of the engine is raised to a value determined by the calculated engine speed parameter value.

Thus, it is especially desirable to control the engine speed parameter value when the vehicle engine is subjected to a high load, which may take place during an uphill travel by the vehicle and/or when the vehicle is carrying a heavy load.

According to a further embodiment, the method therefore comprises the step of determining an efficiency of a converter in the vehicle powertrain on the basis of the detected operating parameter and using the determined converter efficiency for determining the engine speed parameter value. The converter efficiency is a suitable variable for determining the engine speed parameter value since it decreases abruptly when the converter slips, i.e. in the events described above. Further, the converter efficiency does not vary much for different engine speeds in a normal operation interval. Preferably, a speed of an output shaft of the engine and an output speed of a turbine wheel in the converter are detected. The efficiency of the converter is determined on the basis of the detected speed of the output shaft of the engine and the output speed of the turbine wheel.

According to a further embodiment, the method comprises the step of detecting a torque of a vehicle powertrain (for example an engine torque) and determining the engine speed parameter value also on the basis of the detected torque. More precisely, the method comprises the step of selecting values from the stored information (with regard to fuel consumption, reduced emissions and/or increased productivity) on the basis of the detected operating parameter (torque) and determining the engine speed parameter value on the basis of the selected values.

According to a further embodiment, said information regarding fuel consumption, emissions and/or productivity is stored for a specific performance. The specific performance may be a work task such as traveling a distance forwards uphill or transporting a load a distance uphill and/or forwards (preferably traveling up such a slope that the vehicle engine is strained). The specific performance may further comprise performing a predetermined work function with a work implement (such as digging, picking up a load etc). The productivity is for example determined by the time necessary for performing the specific performance.

Further preferred embodiments and advantages will be apparent from the following description and drawings.

### BRIEF DESCRIPTION OF THE DRAWINGS

The invention will be explained below, with reference to the embodiments shown on the appended drawings, wherein

FIG. 1 schematically shows a wheel loader in a side view,

FIG. 2 is a block diagram of a machine stability system of a preferred embodiment of the present invention,

FIG. 3 is a flow chart diagram of a first preferred embodiment of the present invention,

FIG. 4 is a flow chart diagram of a second preferred embodiment of the present invention, and

FIG. 5-7 are block diagrams presenting fuel consumption, total time and emissions for an exemplary uphill travel.

### DETAILED DESCRIPTION

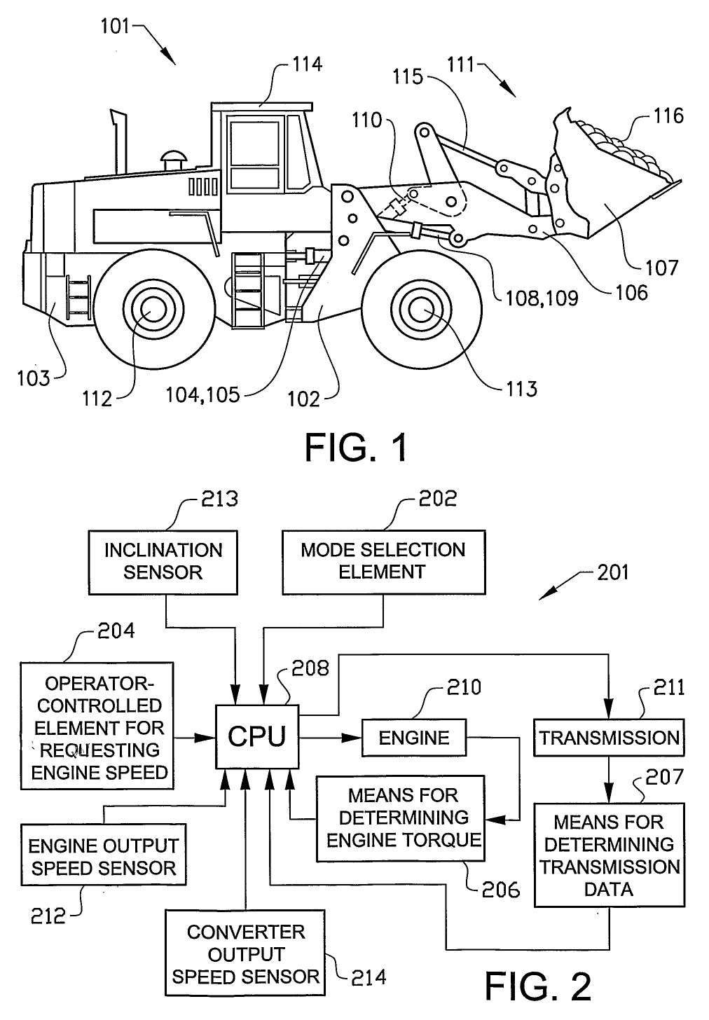

FIG. 1 shows a wheel loader 101. The body of the wheel loader 101 comprises a front body section 102 with a front frame, and a rear body section 103 with a rear frame, which sections each has a pair of half shafts 112, 113. The rear body section 103 comprises a cab 114. The body sections 102, 103 are connected to each other via an articulation joint in such a way that they can pivot in relation to each other around a vertical axis. The pivoting motion is achieved by means of two first actuators in the form of hydraulic cylinders 104, 105 arranged between the two sections. Thus, the wheel loader is an articulated work vehicle. The hydraulic cylinders 104, 105 are thus arranged one on each side of a horizontal centerline of the vehicle in a vehicle traveling direction in order to turn the wheel loader 101.

The wheel loader 101 comprises an equipment 111 for handling objects or material. The equipment 111 comprises a load-arm unit 106 and an implement 107 in the form of a bucket fitted on the load-arm unit. A first end of the load-arm unit 106 is pivotally connected to the front vehicle section 102. The implement 107 is pivotally connected to a second end of the load-arm unit 106.

The load-arm unit 106 can be raised and lowered relative to the front section 102 of the vehicle by means of two second actuators in the form of two hydraulic cylinders 108, 109, each of which is connected at one end to the front vehicle section 102 and at the other end to the load-arm unit 106. The bucket 107 can be tilted relative to the load-arm unit 106 by means of a third actuator in the form of a hydraulic cylinder 110, which is connected at one end to the front vehicle section 102 and at the other end to the bucket 107 via a link-arm system 115.

In operation of the wheel loader, the operator picks up a load 116 with the implement 107 and begins to travel to another location.

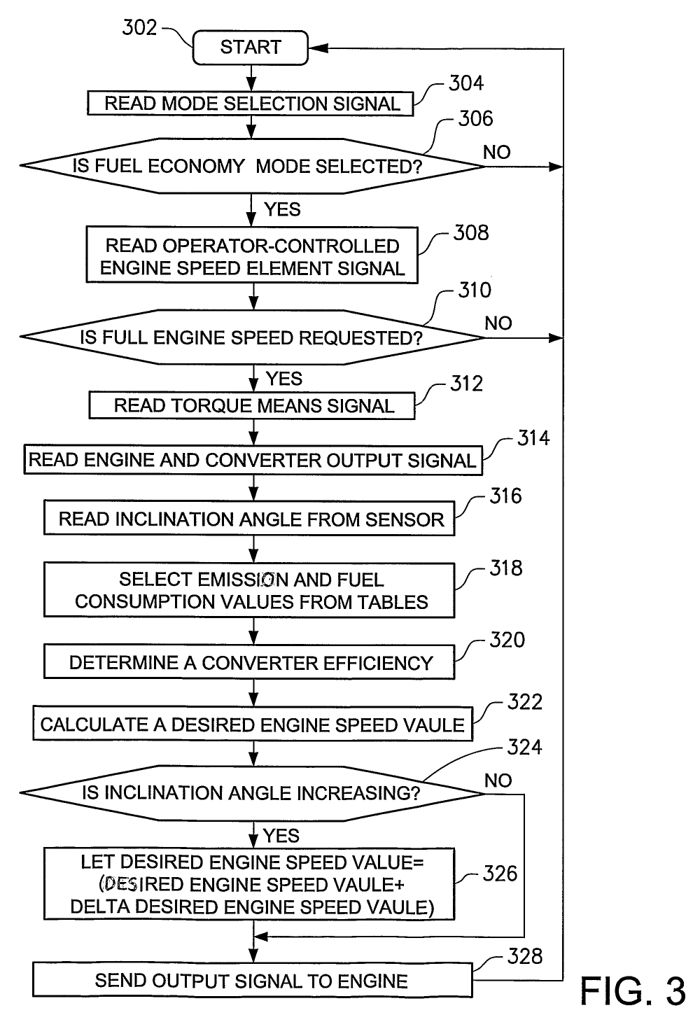

A preferred embodiment of a vehicle control system 201 is disclosed in a block diagram in FIG. 2. The control system 201 comprises a mode selection element 202. The mode selection element 202 may be formed by a push button or a rotary knob. The mode selection element 202 is arranged for being actuated by the driver and responsively producing a signal. At least two different modes may be selected by means of the mode selection element 202 comprising a fuel economy mode. According to an alternative, the fuel economy mode is preset (standard) and the operator can deactivate the fuel economy mode by operating the mode selection element.

The control system 201 comprises an operator-controlled element 204 which is adapted for requesting an engine speed and responsively producing a signal. The operator-controlled element 204 is for example a gas pedal. The control system 201 further comprises an engine output speed sensor 212, a vehicle inclination sensor 213, a converter output speed sensor 214, means 206 for determining an engine torque and means 207 for determining transmission data. Said means for determining an engine torque 206 may be formed by an engine controller, which monitors fuel consumption, engine speed etc and determines engine torque on the basis of such values. Said means 207 for determining transmission data is according to one example detecting a converter output speed and transmission output speed.

The control system 201 comprises a controller 208 operatively connected to the mode selection element 202, the operator-controlled engine speed element 204, the engine speed output sensor 212, the vehicle inclination sensor 213, the converter output speed sensor 214, said means for determining an engine torque 206 and said means 207 for determining transmission data for receiving signals from each of them. The controller 208 is commonly known as a central processing unit (CPU) or an electronic control module (ECM). In a preferred embodiment, the controller is a microprocessor.

The control system 201 comprises an engine 210 for propelling the vehicle 101. The controller 208 is operatively connected to the engine for controlling an engine speed. The control system 201 further comprises a transmission 211 operatively coupled to and driven by the engine 210. The controller 208 is operatively connected to the transmission for controlling gear shifting points.

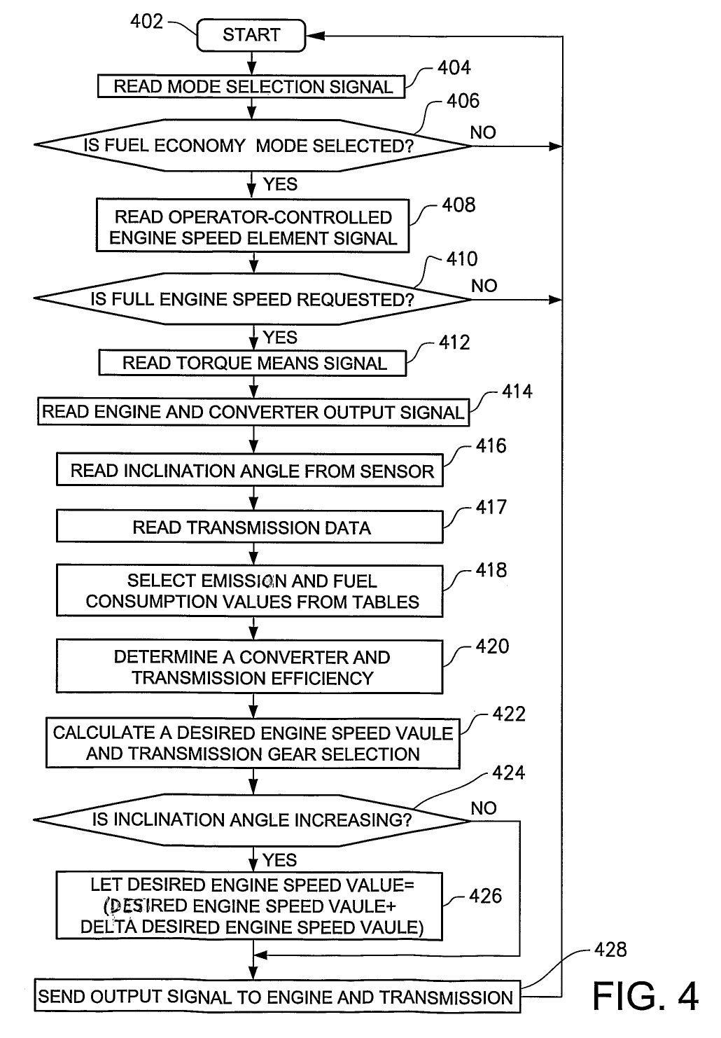

FIG. 3 illustrates a first embodiment of a flowchart of the method of the present invention. The logic starts at the start block 302. The controller 208 then proceeds to the read block 304 in which it reads the mode selection signal. Next, the controller 212 proceeds to the read block 306, in which it determines if a fuel economy mode is selected. If the fuel economy mode is selected, it proceeds to block 308, in which it reads a signal of a desired engine speed from the operator-controlled element 204. In block 310, it determines if full engine speed is requested. If full engine speed is requested, it proceeds to block 312, in which it reads an engine torque signal.

In block 314, the controller 208 reads engine and converter output speed sensor signals. In block 316, the controller 208 reads an inclination angle of the vehicle from a vehicle inclination angle sensor.

In block 318, the controller selects a fuel consumption value and emission values of HC, CO and NO from look-up tables on the basis of the determined engine torque. More specifically, one table is provided with a plurality of values for fuel consumption for different operating conditions. One or a plurality of tables are provided for different emissions like HC, CO and NO with a plurality of values for the emissions for different operating conditions. The fuel consumption and emissions are more or less directly dependant on the engine torque but varies depending on the engine speed.

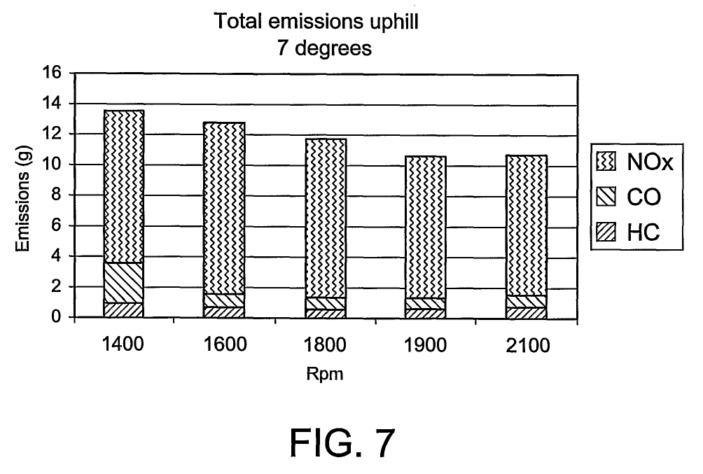

According to one example, values for total fuel consumption and total time for traveling uphill a slope of 7 degrees have been determined for different engine speeds for an exemplary vehicle, see table 1 below and FIGS. 5 and 6. It is noted that a minimum fuel consumption is achieved at an engine speed of 1900 rpm.

Table 1

TABLE 1

| Rpm | Litre | Seconds |
|---|---|---|
| 1400 | 0.50 | 165 |
| 1600 | 0.43 | 103 |
| 1800 | 0.40 | 79 |
| 1900 | 0.37 | 70 |
| 2100 | 0.41 | 48 |

Further, emission values of HC, CO and NO for traveling uphill the slope of 7 degrees have been determined for different engine speeds for an exemplary vehicle, see table 2 below and FIG. 7. It is noted that a minimum of total emissions is achieved at an engine speed of 1900 rpm.

Table 2

TABLE 2

| | | | | Total |
|---|---|---|---|---|
| Rpm | HC | Co | NOx | emissions |
| 1400 | 0.94 | 2.63 | 9.97 | 13.54 |
| 1600 | 0.52 | 0.86 | 11.39 | 12.77 |
| 1800 | 0.40 | 0.78 | 10.55 | 11.73 |
| 1900 | 0.45 | 0.71 | 9.46 | 10.62 |
| 2100 | 0.57 | 0.79 | 9.34 | 10.70 |

In block 320 an efficiency of the converter is calculated by dividing the values of the engine output speed and the converter output speed. Further, the controller proceeds to block 322, in which it uses the following formula to calculate a value for a plurality of engine speeds:

N1:(fci+HCi+COi+NOi)/ηc

### Where

fc is fuel consumption,
HC is Hydrogene Carbonic emission,
CO is Carbonic Oxides emission,
NO is Nitrogene Oxides emission, and
ηc is converter efficiency

In block 324, the controller determines if the vehicle inclination angle is increasing. Thus, when the vehicle reaches an uphill slope, the controller can determine that the vehicle is in the slope before the engine is subjected to a substantially higher load, and in block 326, the engine speed value is increased correspondingly. Since the vehicle has a kinetic energy during traveling towards the uphill slope, this operational step creates conditions for a faster response in an uphill slope and therefore a more efficient operation.

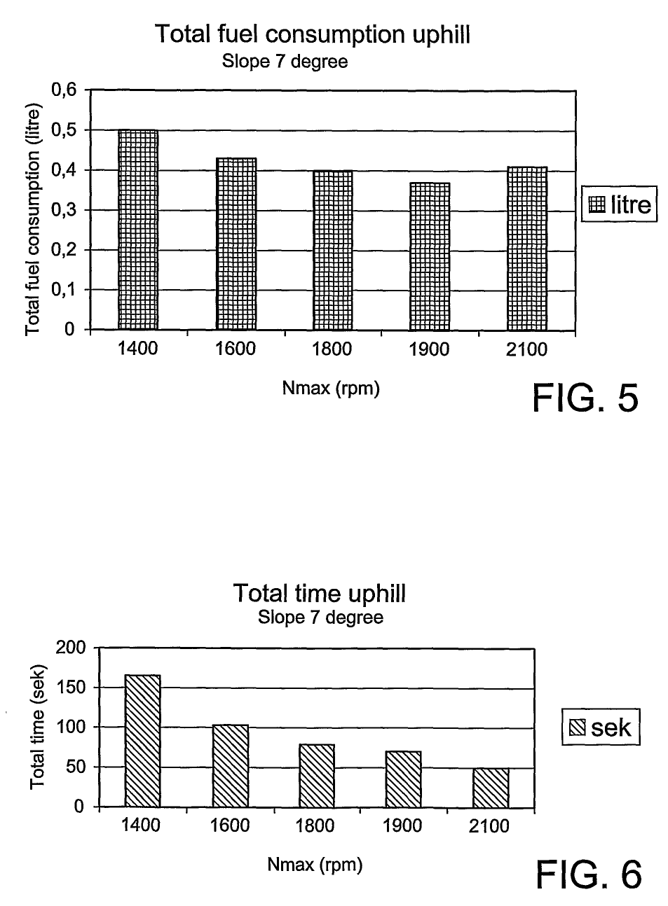

FIG. 4 illustrates a second embodiment of a flowchart of the method of the present invention. The second embodiment differs from the first embodiment in that in addition to controlling the engine speed, also the transmission is controlled. Only the additional steps of the second embodiment will be described below.

In step 417, transmission data is read via said means 207. In step 420, a transmission efficiency is read from a table for different speeds. In step 422, a gear in the transmission is selected on the basis of the transmission efficiency.

In step 428, an output signal is sent to the transmission in order to change gears in order to minimize fuel consumption and/or emissions and/or operation time.

Further, according to an alternative, the engine speed is determined on the basis of energy losses of one or several further components/devices in the vehicle powertrain. The losses in the transmission may for example be used. In such a case, the controller uses the following formula to calculate a value for a plurality of engine speeds:

N1:(fci+HCl+COi+NOi)/(ηc*ηt)

Where ηt is transmission efficiency

In any of the embodiments described above, the calculated final values of the formula above are compared and the engine speed leading to the lowest final value is selected. The speed of the engine 210 is controlled according to the selected engine speed value. Thus, a responsive output signal is sent to the engine in block 328, 428 and the engine speed is controlled accordingly. In other words, the requested engine speed signal from the operator controlled element (gas pedal) is modified/manipulated in the controller 208.

According to one embodiment of the invention, a driver of the vehicle may therefore depress the gas pedal completely and maintain it completely depressed and the engine speed is automatically controlled for an optimized operation with regard to fuel consumption, emissions and/or productivity.

The method of FIGS. 3 and 4 is performed frequently enough to provide the desired resolution and time responsiveness for determining the optimized engine speed parameter value, and controlling the engine in accordance with the determined engine speed parameter value.

The above described process for determining an engine speed value and controlling the engine accordingly may be used regularly independent of any specific performance. However, the control method is preferably used for an operation state in which the engine is or will be subjected to a high load, such as during transporting a load up a slope. Thus, the steps 324, 326; 424, 426 are optional. This is one example of a specific performance, or work task, when it is desirable to be able to vary the (maximum) engine speed depending on certain operating conditions. According to one embodiment, certain operating parameters are therefore detected in order to determine when the vehicle is operated for the specific performance. In order to determine whether the vehicle is about to transport a load up a slope, both a vehicle inclination and an engine load is detected. The engine speed parameter is optimized during the movement uphill if the detected vehicle inclination is above a predetermined vehicle inclination value and the detected engine load value is above a predetermined engine load value.

Further, the above described process for determining an engine speed value and controlling the engine accordingly may be used regularly independent of any specific work mode. Thus, determining whether the vehicle is in the fuel economy mode should be regarded as a preferred option.

According to one alternative to the above described example where the engine speed is controlled, the engine speed parameter is optimized by raising a limit for a maximum available engine torque depending on the detected operating parameter (s) and the stored values of fuel consumption, emissions and/or productivity. Thus, in such a case, any detection of an operator-controlled element which is adapted for requesting an engine speed is not required. Instead, the operator controls the engine torque directly by actuation of the operator-controlled element as long as the determined limit is not reached. When the limit is reached, the controller controls the engine torque in accordance with the determined limit value.

According to a further development of the method described above, it comprises the step of optimizing operation of the work vehicle when used in a repetitive operation, storing information regarding fuel consumption, emissions and/or time for the travel uphill during a travel uphill and using the stored information from a past performance uphill. Thus, it is an adaptive system.

The values of fuel consumption, emissions and productivity used by the controller 208 may be taken from a table, a formula, an algorithm, or any combination thereof.

The invention is not in any way limited to the above described embodiments, instead a number of alternatives and modifications are possible without departing from the scope of the following claims.

In the embodiments described above with regard to FIGS. 3 and 4, there is no internal weighing of the parameters fuel consumption and the emissions HC, CO and NO. However, the formula can easily be amended in order to weigh one or several of the different parameters more than others. Further, HC, CO and NO should only be regarded as three examples of emissions. The method may of course take into account emissions of further additional compounds or replace one or several of the defined compounds with others.

The invention is of course applicable for carrying loads with other types of implements, like forks or grip arms for log handling.

1. A method for optimizing operation of a work vehicle with an engine for propelling the vehicle, comprising
detecting at least one operating parameter,
determining an optimized engine speed parameter value with regard to fuel consumption, reduced emissions and/or increased productivity on the basis of the detected operating parameter and stored information regarding fuel consumption, emissions and/or productivity,
detecting actuation of an operator-controlled element which is adapted for requesting an engine speed,
determining if the vehicle is in an operator selected fuel economy mode,
initiating determination of the engine speed parameter value if full engine speed is requested by the operator and only if the vehicle is in said operator selected fuel economy mode and
controlling the engine in accordance with the determined engine speed parameter value.

2. A method according to claim 1, wherein the optimized engine speed parameter value is an engine speed value, and the method comprises controlling the actual engine speed to the determined engine speed value.

3. A method according to claim 1, comprising calculating the engine speed parameter value as a function of the stored information and the detected operating parameter.

4. A method according to claim 1, comprising determining an efficiency of a converter in the vehicle powertrain on the basis of the detected operating parameter and using the determined converter efficiency for determining the engine speed parameter value.

5. A method according to claim 1 comprising determining an efficiency of a transmission in the vehicle powertrain on the basis of the detected operating parameter and using the determined transmission efficiency for determining the engine speed parameter value.

6. A method according to claim 1, comprising determining a torque of a vehicle powertrain and determining the engine speed parameter value also on the basis of the determined torque.

7. A method according to claim 1, comprising selecting values from the stored information on the basis of the detected operating parameter and determining the engine speed parameter value on the basis of the selected values.

8. A method according to claim 1, comprising controlling a limit for a maximum available engine speed.

9. A method according to claim 1, comprising using stored information of at least fuel consumption and emissions and determining an optimized engine speed parameter value with regard to fuel consumption and reduced emissions.

10. A method according to claim 1, comprising using stored information of at least two of the parameters fuel consumption, emissions and productivity.

11. A method according to claim 1, comprising using stored information of all three parameters fuel consumption, emissions and productivity.

12. A method according to claim 1, comprising the step or determining if the vehicle is in a predetermined operation state and initiating determination of the engine speed parameter value only if the vehicle is in said predetermined operation state.

13. A method according to claim 12, wherein the predetermined operation state corresponds to that a vehicle engine is subjected to a high load.

14. A method according to claim 12, wherein the predetermined operation state corresponds to an uphill travel by the vehicle.

15. A method according to claim 12, wherein the predetermined operation state corresponds to the vehicle carrying a heavy load.

16. A method according to claim 12, comprising determining if the vehicle is in the predetermined operation state by detecting at least one operating parameter.

17. A method according to claim 12, comprising detecting an engine load, comparing the detected engine load value with a predetermined engine load value and determining that the vehicle is in the predetermined operation state if the engine load value is above the predetermined engine load value.

18. A method according to claim 12, comprising detecting a vehicle inclination, comparing the detected vehicle inclination value with a predetermined vehicle inclination value and determining that the vehicle is in the predetermined operation state if the vehicle inclination value is above the predetermined vehicle inclination value.

19. A method according to claim 1, wherein the vehicle is adapted for operation in a mode selected by an operator from a set of modes comprising a fuel economy mode and at least one further operation mode, comprising performing the method steps if the vehicle is in the selected fuel economy mode.

20. A method according to claim 1, wherein said information regarding fuel consumption, emissions and/or productivity is stored for a specific performance.

21. A method according to claim 20, wherein the performance comprises travel a distance uphill.

22. A method according to claim 20, wherein the performance comprises performing a predetermined work function with a work implement.

23. A method according to claim 1, comprising comparing values for the engine speed parameter value from at least one table for the fuel consumption, emissions and/or productivity, selecting a specific engine speed parameter value and controlling the engine accordingly.

24. A method according to claim 1, comprising optimizing operation of the work vehicle when used in a repetitive operation, storing information regarding fuel consumption, emissions and/or productivity during a specific performance and using the stored information in a consecutive performance.

25. A computer program comprising software code for carrying out all the steps as claimed in claim 1 when the program is run on a computer.

26. A computer program product comprising software code stored on a medium that can be read by a computer for carrying out all the steps as claimed in claim 1 when the program is run on a computer.
